(19) United States
(12) Patent Application Publication
(10) Pub. No.: US 2016/0128902 A1
(43) Pub. Date: May 12, 2016

(54) Chair with Backrest Having Pressure Points for Stimulating Mechanoreceptors

(71) Applicant: JCC&P, LLC, Fort Wayne, IN (US)

(72) Inventor: James M. Cox, Fort Wayne, IN (US)

(73) Assignee: JCC&P, LLC, Fort Wayne, IN (US)

(21) Appl. No.: 14/538,067

(22) Filed: Nov. 11, 2014

(51) Int. Cl. A61H 39/04; A47C 7/40; A47C 3/00

(52) U.S. Cl. CPC A61H 39/04; A47C 3/00; A47C 7/40

(57) ABSTRACT

A chair having a backrest with pressure points arranged in rows corresponding to vertebra in the cervical, thoracic and lumbar sections of the spine. The rows within the cervical and thoracic sections have at least four pressure points spaced laterally. The rows within the lumbar section have more than four pressure points spaced laterally. Within the lumbar section, each successive row includes at least two more pressure points spaced laterally than the previous row. The pressure points each include a protuberance embedded within a layer of elastomeric foam material and each protuberance includes a tip portion that is free of the layer of foam material. The tip portions project from a recessed surface from a backrest surface and are located within a void formed between the recessed surface and a flexible cover. The pressure point afferentation backrest for stimulation of mechanoreceptors is the neuroanatomical clinical outcome basis for the invention.

### BACKGROUND OF THE INVENTION

1. Field of the Invention

The present invention relates generally to chairs having ergonomic backrests for supporting healthy sitting posture, and more specifically to such chair backrests having pressure points for stimulating mechanoreceptors for afferentation to alleviate back pain.

2. Description of the Related Art

The related art includes a variety of chairs that are ergonomically shaped for comfort and for avoiding back pain while sitting for long periods of time, such as at an office desk. One such chair is shown in U.S. Pat. No. 7,234,775 to Serber, which chair includes a seat supported to swing about a center located at approximately the center of mass of a person sitting in the chair.

U.S. Pat. No. 6,589,143 to Taylor shows a portable back pain reliever for use with the backrest of a chair in which bi-pad supports are disposed along the spine of a person so each of the two pads are on opposite sides of the spine.

Back pain afflicts 80% of humans at some point in their lives. No specific cure exists for it but prevention and accommodation for pain relief are priority considerations in dealing with this progressive disease.

Sitting raises the pressure inside the human intervertebral disc eleven times the pressure at lying down. Maintaining low intradiscal pressure aids in preventing tearing of the annulus fibrosis fibers of the disc. This tearing produces chemicals that irritate the nerves in the disc as well as allowing the inner substance of the intervertebral disc, the nucleus pulposus, to protrude or herniate out of its inner confines of the disc to enter the outer fibers of the disc which are very pain sensitive.

Intervertebral disc degeneration, elevated intradiscal pressure, spinal stenosis, congenital conditions such as spondylolisthesis, and transitional vertebra, trauma, poor health and deconditioning are all factors contributing to back pain.

In an attempt to make sitting pain relieving and ergonomically corrective to the spine's physiological curves, the sitting sagittal posture should be attained and maintained in the most pain relieving posture. Quality of life in low back pain patients is low, necessitating interventions of rehabilitation for improvement. Proper sitting posture will support the normal spinal curves and reduce flexed, rotatory, and lateral bending forces that cause disc tearing and injury.

Joint receptors are found in all synovial joints of the body in mature individuals, including the zygapophyseal joints (facet joints) of the spine. They include: Four varieties of receptor nerve endings are found. Wyke B D: Articular neurology and manipulative therapy. Glasgow E F, Twomey L T, Sculler. Aspects of Manipulative Therapy. Melbourne, Lincoln Institute of Health. L Churchill Livingstone 1985: 72-80. Giles L G F. Anatomical basis of low back pain. Williams & Wilkins 1989. Chapter 6 Innervation of the zygapophyseal joints page 62).

Type I— Mechanoreceptors which consist of clusters of thinly encapsulated globular corpuscles embedded in the outer layers of the fibrous capsule.
Type II— Mechanoreceptors which are thickly encapsulated conical cordpuscles embedded in the deeper layers of the fibrous capsule, fat pad and cutaneous skin;
Type III— Mechanoreceptors which are much larger, thinly encapsulated corpuscles applied to the surfaces of joint ligaments, but which are absent from the spinal ligaments.
Type IV—A receptor system in the fibrous capsules of the joints which is represented by a plexus of unmyelinated nerve fibers, which weave in three dimensions throughout the entire thickness of the joint capsule but are entirely absent from synovial tissue and intra-articular menisci. The irritation of the system is said to be responsible for evoking joint pain.

Lamina of gray matter transmit the sensations of touch, pressure, vibration, stretch, etc. Lamina I transmits pain and temperature; Lamina II is the substantia gelatinosa and transmits non-myelinated C fibers for pain; Lamina III, IV, V, VI transmit descending input from the brain to the spine; Lamina VII contains Clarke's nucleus and relays limb position and cerebellar movement; Lamina VIII regulates muscle coordination; Lamina IX transmits motor neurons to muscles; and, Lamina X transmits sensory stimulation.

The spinal posture in the sagittal plane in the desirable pain relieving posture is individually specified for a particular patient's own spine. Physiological spine curves are as follows: Neck (cervical) and low back (lumbar) are lordotic, that is they curve forward; Torso (thoracic) spine and pelvis (sacral) are kyphotic curvatures, that is they curve backward.

It would be desirable to provide a chair having a backrest with pressure points for stimulating mechanoreceptors for afferentation to alleviate back pain. This and other desirable features are provided by the present invention illustrated and described herein in terms of a preferred embodiment.

### SUMMARY OF THE INVENTION

In one form thereof, the present invention is directed to a chair having a backrest including a plurality of pressure points arranged in multiple rows. Each row corresponds to a vertebra of a human spine. The rows are disposed within cervical, thoracic and lumbar sections. Each of the rows within the cervical section has at least four pressure points spaced laterally. Each of the rows within the thoracic section has at least four pressure points spaced laterally. Each of the rows within the lumbar section has more than four pressure points spaced laterally.

In another form thereof, the present invention is directed to a chair having a mounting assembly supporting a seat and a backrest with the backrest adapted to pivot relative to or with the mounting assembly. The backrest includes a plurality of pressure points arranged in multiple rows. Each row corresponds to a vertebra. The rows are disposed within cervical, thoracic and lumbar sections. Each of the rows within the cervical section has at least four pressure points spaced laterally. Each of the rows within the thoracic section has at least four pressure points spaced laterally. Each of the rows within the lumbar section has more than four pressure points spaced laterally.

Preferably, each of said pressure points includes a separate protuberance embedded within a layer of elastomeric foam material and each protuberance includes a tip portion that is free of the layer of foam material. A layer of elastomeric foam material is provided and each pressure point includes a tip portion that is free of the layer of foam material.

More preferably, the row of pressure points corresponding to the first lumbar vertebrae includes at least six pressure points, the row of pressure points corresponding to the second lumbar vertebrae includes at least eight pressure points, the row of pressure points corresponding to the third lumbar vertebrae includes at least ten pressure points and, the rows of pressure points corresponding to the fourth lumbar vertebrae, the fifth lumbar vertebrae, and the first sacral vertebrae each include at least twelve pressure points.

The backrest is preferably anatomically curved and includes an adjustable element connected to the pressure points for varying the curvature of the backrest. The adjustable element includes a flexible sheet and adjustable supports connected to the flexible sheet.

In another form thereof, the present invention is directed to a chair having a backrest including a plurality of pressure points arranged in multiple rows. Each row corresponding to a vertebra. The rows are disposed within cervical, thoracic and lumbar sections. Each of the pressure points include a separate protuberance. The protuberances project from a layer of elastomeric foam material and each protuberance includes a tip portion that is free of the layer of foam material.

Preferably, the layer of elastomeric material includes a recessed surface relative to a backrest supporting surface thereby defining a recess, and the tip portions of the protuberances are located in the recess and project from the recess surface. A flexible cover extends over the recess surface and is in contact with the backrest surface thereby forming a void between the cover and the recessed surface wherein the protuberance tip portions are located.

More preferably, the backrest is adapted to move relative to or with the chair. The recessed surface and the supporting surface extend along the backrest cervical, thoracic and lumbar sections and are anatomically curved. The elastomeric material and plurality of pressure points are supported on a flexible sheet and the flexible sheet is connected to adjustable supports whereby the flexible sheet is selectively adjusted for adjusting the anatomical curvature of the cervical, thoracic and lumbar sections.

In yet another form thereof, the present invention is directed to a method of making a chair having a backrest. First, the parameters of the spine of a person for whom the chair is to be made are measured. Then, the chair backrest is made having a plurality of pressure points arranged in multiple rows. Each row corresponds to and is aligned with a vertebra of the spine. Each of the pressure points includes a separate protuberance. A layer of elastomeric foam material from which the protuberances project is provided and each protuberance includes a tip portion that is free of the layer of foam material.

Preferably, the backrest is made with the rows arranged within cervical, thoracic and lumbar sections, with each of the rows within the cervical section having at least four pressure points spaced laterally, with each of the rows within the thoracic section having at least four pressure points spaced laterally and, with each of the rows within the lumbar section having more than four pressure points spaced laterally.

Yet more preferably, the layer of elastomeric material is made with a recessed surface relative to a backrest supporting surface thereby defining a recess and with the tip portions of the protuberances located in the recess and projecting from the recess surface. A flexible cover is extended over the recess surface and in contact with the backrest surface thereby forming a void between the cover and the recessed surface wherein the protuberance tip portions are located. The backrest is also preferably mounted on a mounting assembly and is adapted to move relative to or therewith.

### BRIEF DESCRIPTION OF THE DRAWINGS

The above mentioned and other features and objects of this invention, and the manner of attaining them, will become more apparent and the invention itself will be better understood by reference to the following description of the embodiments of the invention taken in conjunction with the accompanying drawings, wherein:

FIG. 1 is a perspective view of a prior art ergonomic office chair;

FIG. 2 is a side view of an embodiment of a chair having a backrest according to the present invention;

FIG. 3 is a cross-sectional view of the backrest of the chair of FIG. 2 taken in the sagittal plane relative to the spine of a person sitting in the chair, and showing a human spine for reference;

FIG. 4 is a dorsal view of a human spine and showing in schematic fashion the location of pressure points of the backrest of the present invention relative to the vertebrae of the spine; and,

FIG. 5 is a perspective view of the backrest of FIGS. 2 and 3, shown partially cut away.

Corresponding reference characters indicate corresponding parts throughout several views. Although the exemplification set out herein illustrates embodiments of the invention, in several forms, the embodiments disclosed below are not intended to be exhaustive or to be construed as limiting the scope of the invention to the precise forms disclosed.

### DETAILED DESCRIPTION OF THE PREFERRED EMBODIMENTS

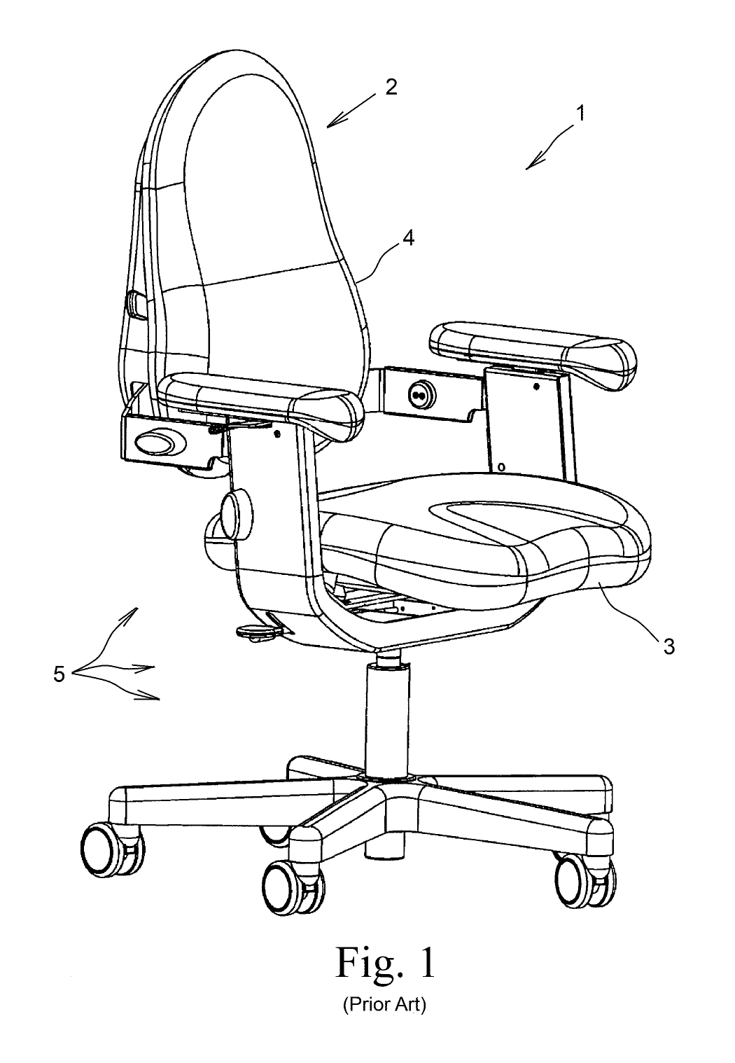

Referring to FIG. 1, there is illustrated a prior art chair 1 of a preferred type having a swinging seat that is useful in combination with the chair backrest of the present invention. Chair 1 includes a seat assembly 2 including a seat 3, a backrest 4 and a mounting assembly 5 mounting the seat 3 in a near horizontal orientation for movement along an upwardly concaved arcuate seat path having a center of curvature proximate the center of mass of a person seated on the seat, and mounting the backrest 4 in a near vertical orientation for movement independently of the seat along a forwardly concaved arcuate path having a center curvature proximate the center of mass of the person.

Other aspects of the prior art chair of FIG. 1 are shown and described in U.S. Pat. No. 7,234,775 to Serber, which is hereby incorporated by reference.

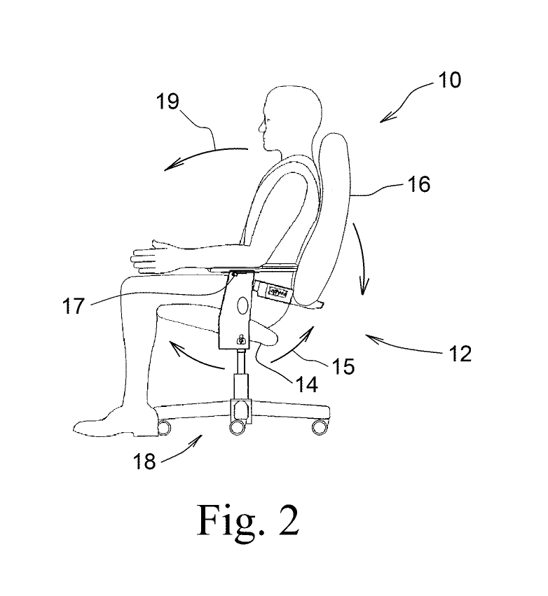

Referring to FIGS. 2-5, there is illustrated an example of a preferred chair of the type as illustrated in FIG. 1 except that the backrest 4 has been replaced with a backrest 16 configured in accordance with the present invention to stimulate mechanoreceptors in the spine and its structures, including the intervertebral disc, facet joints, synovial lining of the facet joints, ligaments, tendons, Golgi apparatus, muscles and cutaneous skin. Mechanoreceptors are sensory receptors of nerves that are sensitive to mechanical changes involving movement, tension, pressure, vibration, or another mechanical stimulus, and provide the person with information about such mechanical changes.

Some aspects of a chair backrest according to the present invention are intended to:
1. Create afferentation of the mechanoreceptors to establish normoexcitatory reflexes to the spinal dorsal root ganglion and brain;
2. Produce healthy endorphine production to relieve pain and create a sense of well-being in a patient;
3. Regain afferentation in chronic pain patients who have lost their receptors to the process of deafferentation;
4. Block pain by stimulation of the internuncial neuron in the dorsal root ganglion. This is accomplished by stimulating the large A fibers for touch, temperature, and pressure. No stimulation of nociceptors (pain producers) is done; and,
5. Reduce chemical inflammation of the disc and facet joints via stimulation of joint blood circulation.

PRINCIPLES OF PAIN CONTROL: The balance of activity in the large A fibers for touch, temperature and pressure with the small nociceptive pain fibers is important for pain control and proprioception balance of the nervous system. Stimulation of large myelinated mechanoreceptors restores normal activity and balance between small nociceptive pain fibers and the large myelinated fibers and pain is relieved. The concept of pain relief being the balance of activity in nociceptive pain afferents and non nociceptive large nerve fibers is called the gate control theory and simply says that non-nociceptive afferents close and nociceptive afferents open a gate to the central transmission of noxious input. (Eric Kandel, James Schwartz, Thomas Jessell. Principles of Neural Science, Third Edition, 1991, Appleton & Lange 392) The validity of the Gate Control Theory is supported by Dickenson et al. (Dickenson A H: Gate Control Theory of pain stands the test of time: British j of Anaesthesia. June 2002; Vol 88; No 6: p 755-57) Kirkaldy-Willis discussed how the key to successfully managing chronic low back pain is through the utilization of applied motion. The motion ranges from active range of motion, passive range of motion, and motion beyond normal or physiological range of motion which is a spring like end feel. (Kirkaldy-Willis W H, Cassidy J D: Spinal manipulation in the treatment of low back pain; Canadian Family Physician; March 1985, Vol 31. pp. 535-40) (Kirkaldy-Willis: The Perception of Pain. Managing Low Back Pain. 1983: 45-49, Churchill-Livingstone). It is this concept that this patented back rest is developed.

Proprioception is the awareness of position and/or movement and is derived from mechanoreceptive nerve endings in the muscles, tendons, and articular joints. Information from these mechanoreceptors is transmitted to the sensory neurons to the spinal cord and brain via the dorsal horn. Adverse or inappropriate mechanical events can create a mismatch of communication within the feedback loop, which is deleterious and opens pain channels, (Kandel E R, Schwartz J H, Jessell T M; Principles of Neural Science, Appleton & Lange: 359-362).

AFFERENTATION: Afferentation is the sum total of sensory input from a body part or region. Deafferentation is the loss of afferentation from the peripheral body to the brain due to such conditions as degenerative disease (disc, meniscus, and muscle), arthritis, bursitis, sedentary life, depression, nutritional disease, etc. Afferentation results from the stimulation of mechanoreceptors in the human skin, joints of the spine including the intervertebral disc, facet joints, ligaments, tendons and muscles, and linings of the spinal joints and appendicular joints. Stimulation of mechanoreceptors results in afferentation that can also block pain reflexes to the brain or spinal cord.

Physiologists have recognized for decades that alterations in muscle activity have the potential to alter cerebral function. This relationship is perhaps best defined by the afferentation theory of cerebral arousal. In its simplest form, afferentation theory predicts that agents or maneuvers that produce muscle stretch or contraction, or directly stimulate muscle stretch receptors (i.e., muscle afferents), will produce cerebral stimulation. (Lanier W L, The Affeventation Theory of Cerebral Arousal. Developments in Critical Care Medicine and Anesthesiology. Neuroanesthesia, Vol. 32, 1997: 27-38. Neck, costovertebral, and upper back pain, depending upon the degree of pain, show decreased cerebral perfusion in the frontal and parietal areas of the brain as measured with SPECT CT scanning. Spinal joint dysfunction may be involved via hyperactivity in the regional sympathetic nervous system. The anatomy of the somatosensory system allows both serial and parallel information flow but the conditions involving each mode of processing is a matter of debate. In a functional magnetic resonance imaging (fMRI) study, cutaneous electrical stimulation was applied to human volunteers at three intensities (low-innocuous, moderate-noxious and high-noxious) to investigate interactions between contralateral primary and secondary somatosensory cortices of the brain. The more intense stimulus also induced significantly more interactions between the brain cortices, (Knoshnejad M, Piche M, Saleh S, Duncan G, Rainville P. Sensory processing in primary and secondary somatosensory cortex: A DCM analysis of human fMRI data in response to innocuous and noxious electrical stimulus. Neurosci Lett. 2014 Jun. 13. Pii:S0304-3940(14)00485-6.doi: 10.1016/j.neulet.2014.06.013.).

INTERVERTEBRAL DISC NERVE INNERVATION: The presence of nerve elements within the intervertebral disc indicates that the mechanical status of the disc is monitored by the central nervous system. These mechanoreceptors provide basic proprioception function, specifically the sense of compression, deformation, and alignment. The intervertebral disc is innervated with mechanoreceptors which may go as deep as the nucleus pulposus of the disc. These mechanoreceptors provide basic proprioceptive function, specifically the sense of compression, deformation, and alignment. (Mendel T, Wink C S, Zimny M L: Neural elements in human cervical intervertebral discs. Spine 1992:17(2); 132-5) (Roberts S, Eisenstein S M, Menage J, Evans E H, Ashton I K: Mechanoreptors in intervertebral discs: morphology, distribution, and neuropeptides. Spine 1995; 20(24); 2645-51) An abundant network of encapsulated and non-encapsulated receptors in the intervertebral discs of the lower lumbar spine n normal human subjects is found which monitor position, velocity and acceleration (kinesthesia). They maintain normal muscle tone and when dysfunctional can create intense muscle spasms. These mechanoreceptors in the lumbar discs provide basic proprioceptive function, specifically for the sense of compression, deformation, kinesthesia, and alignment. (Dimitroulias A, Tsnidis C, Natsis K, Veniaelos I, Djau Sn, Tsitsopoulow P:An immunohistochemical study of mechanoreceptors in lumbar spine intervertebral discs. Journal of Clinical Neuroscience; 2010; 17(6); 742-45) (Yamashita, Minaki Y, Oota I, Yokogushi K, Ishii S, Mechanosensitive Affevent Units in the Lumbar Intervertebral Disc and Adjacent Muscle, Spine 1993, 18(15): 2252-56.

MUSCLE PAIN INVOLVEMENT: One muscle of importance to activate is the multifidus muscle which is found deep in the back muscles. It is reported to reflexly recruit deep core muscles of the torso to provide a sensitive and reactive protective contractile response. The multifidus muscle is a key component in the deep stabilization of the spine and is particularly susceptible to inhibition and atrophy following back injury. It does not naturally recover from post injury inhibition and atrophy. Research is ongoing to find a reversal of this malady. Spinal manipulation has been found to enhance and protect core muscles and the multifidus muscle. Exercise is also found to enhance the stabilization of these muscles. Passive, active and reactive treatment of spinal and core torso muscles is needed to attain maximum patient outcomes. (Morgan W. Manipulation activates muscles of the core. ACA News November 2014. JACA Online) Hip extension in the prone posture may be effective for selective activation of the lumbar multifidus muscles. (Kim J S, Kang M H, Kim J W, Lee D K, Yoon T H, Oh J S: Hip extension in a prone position may be effective for selective activation of the lumbar multifidus muscles in healthy males. J Phys Ther Sci. 2014; 26(8): 1223-4) Incorporation of the concepts of this patent application have potential to rehabilitate the multifidus muscle.

FACET JOINT PAIN ORIGIN: The facet capsules are densely populated with mechanoreceptors. Encapsulated mechanoreceptors are found in the cervical human facet joints. Their presence indicates that the mechanical state of the joint capsule is under constant surveillance of the central nervous system for position, tension, pressure, etc. (McLain R F; Mechanorecptor endings in human cervical facet joints. Spine 1994; 19(5): 495-501) These mechanoreceptors for detecting motion and tissue distortion are also found in the thoracic and lumbar facet joints and again they communicate with the central nervous system to provide basic proprioceptive function for motion, tissue distortion, and position. (McLain R F; Mechanorecptor endings in human cervical facet joints. Spine 1998; 23(2): 168-73). Increased proprioceptive input in the form of spinal mobility tends to decrease the central transmission of pain from adjacent spinal structures by inhibiting pain reflexes. Any therapy which induces motion into articular structures will help inhibit pain transmission by this means. (Kirkaldy-Willis W H, Cassidy J D: Spinal manipulation in the treatment of low back pain; Canadian Family Physician; March 1985, Vol 31. Pp. 535-40) Mechanoreceptor stimulation aid in the perception of joint position and adjustment of muscle tone of the vertebral column. Mechanoreceptors have three primary functions: 1. Enhance spinal function and protect spinal joints against additional injury and future degenerative processes. 2. Provide proprioceptive senses to the central nervous system. 3. Reduce pain. Stretching of facet joint capsules will fire mechanoreceptors which will reflexly inhibit facilitated motoneuron pools which are responsible for muscle spasm that commonly accompany low back pain. (Kirkaldy-Willis W H, Cassidy J D: Spinal manipulation in the treatment of low back pain; Canadian Family Physician; March 1985, Vol 31. Pp. 535-40).

Two mechanisms by which spinal manipulation benefits back pain are:
1. Stretching of the facet joint capsules to fire capsular mechanoreceptors which will reflexly inhibit facilitated motorneuron pools which are responsible for the muscle spasms that commonly accompany low back pain. This relieves pain and improves spinal motion, improves mechanoreception, improves proprioception (balance), and inhibits pain.
2. In chronic cases, there is a shortening of the periarticular connective tissues and intra articular adhesion may form. Spinal manipulation will stretch or break these adhesions and enhance remodeling of other fibrotic tissue changes. This improves patient long term improvement in joint function, mechanoreception, proprioception, neuromuscular controls and pain inhibition.
   It is this mechanoreceptor stimulation and afferentation that is proposed in this patent for seated benefit for those suffering from or wishing to prevent back pain and its accompanying conditions such as headache, arm and leg pain, loss of balance and equilibrium, and general loss of good health.

MUSCLE, FASCIA, TENDON, LIGAMENT MECHANORECEPTION AND AFFERENTATION. The following prominent muscles, tendons, fascia and ligaments known to cause back pain are believed to be affected by the chair back of the present invention that applies pressure point therapy to mechanoreceptors for afferentation:
1. Longissimus dorsi: attached to lumbar vertebrae transverse processes and lumbosacral fascia and attaches to the thoracic spine transverse processes and ribs;
2. Longissimus cervicis: arises from transverse processes of upper thoracic vertebrae to insert into the transverse processes at the second to sixth cervical vertebrae;
3. Longissimus capitis: arises at tendons of transverse process at the upper 4^{th} and 5th thoracic vertebrae to insert at the mastoid processes;
4. Spinalis dorsi: from tendons at the first two lumbar and last two thoracic vertebral spinous processes to insert into the spinous processes of the upper thoracic vertebrae;
5. Spinalis cervicis: from ligamentum nuchae in cervical spine to spinous process of axis;
6. Semispinalis dorsi, cervicis, capitis: these muscles run from transverse processes to spinous processes in the neck, thoracic and occiput;
7. Multifidees: these muscles fill the groove alongside the spinous processes from sacrum to axis. They originate at the sacrum, sacroiliac ligaments, transverse processes and articular processes and cross over from two to four vertebrae toward the mid line to insert into the spinous process from the last lumbar to the axis. This is a very important muscle and some feel it is the most pain producing muscle in the lumbar spine;
8. Interspinalis: between spinous processes;
9. Intertransversarii: between transverse processes of vertebrae;
10. Lumbodorsal fascia: it is the sheath of the sacrospinalis muscle. It is formed from fascia of deep muscles and attaches to the spines of the vertebrae, supraspinal ligaments, and the medial sacrum, iliac crests and sacrum lateral crests. Its deep layers extend over the sacrospinalis and attach to the transverse processes of the lumbar vertebrae. It forms a strong sheet reaching from the twelfth rib to the transverse processes of the lumbar vertebrae. It overlies the quadratus lumborum muscle and psoas muscle (It is noted that at study of the mechanoreceptors in fascia includes include the Golgi reflex arc, Ruffini and Pacini corpuscles for pressure found in ligaments, tendons, aponeuroses, joint capsules, and muscle fascia. They are active in stretch and pressure application. Ruffini corpuscles are also found in the dura mater. Stimulation of Ruffini corpuscles lowers sympathetic nervous system activity and relaxes local tissues. Our largest and richest sensory organ is not the eyes, ears, skin, or vestibular system but is in fact our muscles Type III and IV receptors have autonomic connections and function and stimulation of them leads to a change in heart rate, blood pressure, respiration, etc. Type IV stimulation tends to raise blood pressure Type II can raise or lower blood pressure. Interstitial tissue receptors can find tune the nervous system's regulation of blood flow according to local demands. See Fascial Mechanoreceptors and their Potential Role in Deep Tissue Manipulation, Excerpt from: Schleip R 2003; Fascial plasticity—a new neurobiological explanation. Journal of Bodywork and Movement Therapies 7(1):11-19 and 7(2): 104-116.);
11. Quadratus lumborum: arises from the iliolumbar ligament and iliac rest and inserts into the lower last rib border. Also may originate from the transverse processes of the lower three or four lumbar vertebrae and insert into the last rib; and,
12. Ligament mechanoreceptors have mechanoreptors embedded within them of 4 types: 1. Type I: small low threshold, slow adapting in both static and dynamic settings. 2. Type II: medium low threshold, rapidly adapting in dynamic settings. 3. Large high threshold, slowly adapting in dynamic settings. 4. Very small high threshold pain receptors that communicate injury. (Mechanoreceptor—Wikipedia)

Referring again to FIGS. 2-5, chair 10 has a seat assembly 12 including a seat 14, a backrest 16 and a mounting assembly 18 mounting the seat 14 in a near horizontal orientation for movement along an upwardly concaved arcuate seat path 15 having a center of curvature 17 proximate the center of mass of a person seated on the seat. The mounting assembly 18 further mounts the backrest 16 in a near vertical orientation for movement with or independently of the seat 14 along a forwardly concaved arcuate path 19 having a center curvature 17 proximate the center of mass of the person.

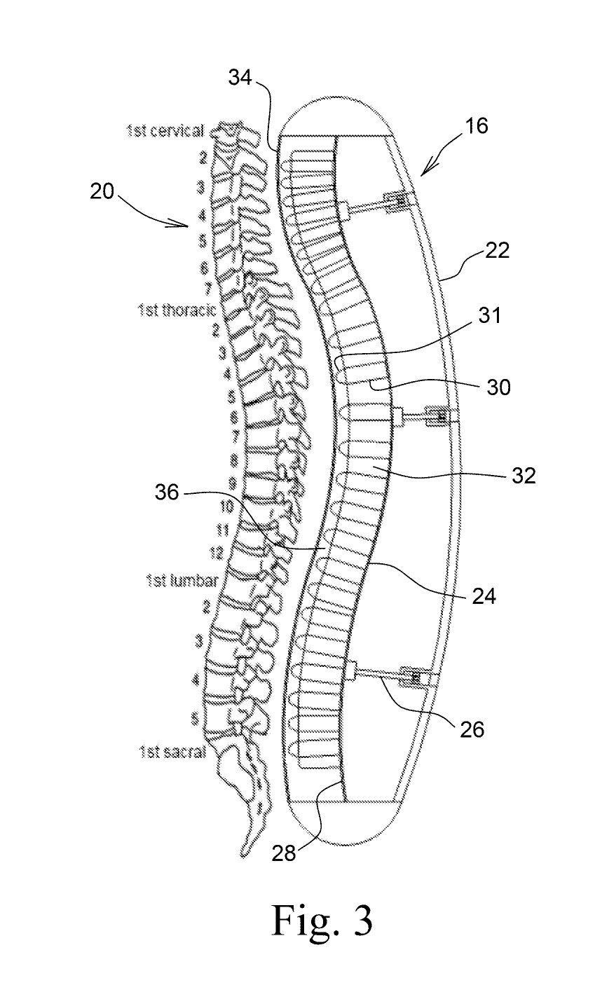

With particular reference to FIG. 3, backrest 16 is shown sectioned bilaterally by a sagittal plane aligned with the center line of the spine 20 of a person as it would be oriented relative to backrest 16 while the person is sitting in chair 10. Backrest 16 includes a back plate 22 concavely curved toward the spine 20 in the sagittal plane, or otherwise shaped as desired for aesthetic and structural reasons. Back plate 22 is relatively rigid to resist flexing and can be made of metal, plastic, composite, or other suitable material. Back plate 22 is secured to mounting assembly 18 for movement as controlled and permitted by mounting assembly 18 preferably in the manner disclosed in U.S. Pat. No. 7,234,775 to Serber.

A curved sheet 24 that is sufficiently stiff to resist buckling or sharp bending, but flexible enough to permit its curved shape to be changed or adjusted, is secured to and supported by back plate 22 via adjustable supports 26. Sheet 24 is anatomically curved to correspond generally in shape to the curvature of the human spine 20, i.e., having a curvature that is lordotic in the cervical and lumbar regions, and that is kyphotic in the thoracic and sacral regions. As preferred, the shape of the curve of sheet 24 can be adjusted to fit a particular person by varying the length of a plurality of adjustable supports 26 to alter the local spacing between sheet 24 and back plate 22 at a number of locations in backrest 16. Adjustable supports are preferably in the nature of screw assemblies that can be adjusted with a suitable tool, such as a hex head wrench, inserted from the rear of back plate 22 to engage a hex recess in the head of the screw, or otherwise configured for external adjustment by tool or by hand. Sheet 24 can be made of sheet metal, plastic or composite material, or other material having the desired mechanical qualities discussed above.

Affixed to the forward face 28 of sheet 24 is a plurality of pegs, protrusions, protuberances or pressure points 30 each preferably configured as a solid cylinder with a rounded pressure point or tip 31 at the forward facing end thereof. There are a total of 24 horizontal rows of pegs 30 and pressure points 31 extending symmetrically to either side of the vertical centerline of backrest 16. Each horizontal row of pressure points 31 corresponds to one of the vertebrae of the cervical, thoracic, lumbar and sacral sections of the spine 20. More particularly, the first six rows of pressure points 31, from the top downward, correspond to the 2^{nd} through 7^{th} cervical vertebrae, respectively. The next following twelve rows of pressure points correspond to the 1^{st} through 12^{th} thoracic vertebrae, respectively. The next following six rows of pressure points correspond to the 1^{st} through 5^{th} lumbar vertebrae and the 1^{st} sacral vertebrae, respectively.

Each of the pegs 30 extends generally normally from the curved front face 28 of sheet 24 and the spacing between rows is selected such that the pressure points 31 of each row align with and point generally toward a transverse imaginary line intersecting the facet joints of the corresponding vertebrae. Consequently, the vertical spacing between horizontal rows of pressure points varies according to the anatomical variation in the height of the vertebrae along the spine. The rows of pressure points in the vicinity of the cervical section of the spine 20 are more closely spaced than those in the vicinity of the thoracic and lumbar sections, for example. To accommodate the close spacing, the cervical pegs 30 are preferably about 0.25 to about 0.375 inches in diameter, whereas the thoracic, lumbar and sacral pegs 30 are preferably about 0.5 inches in diameter.

Interspersed between pegs 30 and forward of sheet 24 is a layer of elastomeric foam 32 to support the back of the person sitting in the chair and generally maintain the spacing between adjacent pegs 30 while allowing for some relative movement between pegs 30 and hence between pressure points 31. Covering foam layer 32 and the rounded tips or pressure points of pegs 30 is a flexible backrest cover 34 that can be made of leather, synthetic plastic material such as upholstery vinyl, natural or synthetic fiber cloth, or other suitable material that is flexible and comfortable. The layer of foam 32 includes a back supporting surface 33 and a recessed surface 35 that preferably is recessed about 0.5 inches back from supporting surface 33, leaving a void space 36 defined between recessed surface 35 of foam 32 and cover 34 (between the tip regions 31 only of adjacent pegs 30) and between recess side walls 37.

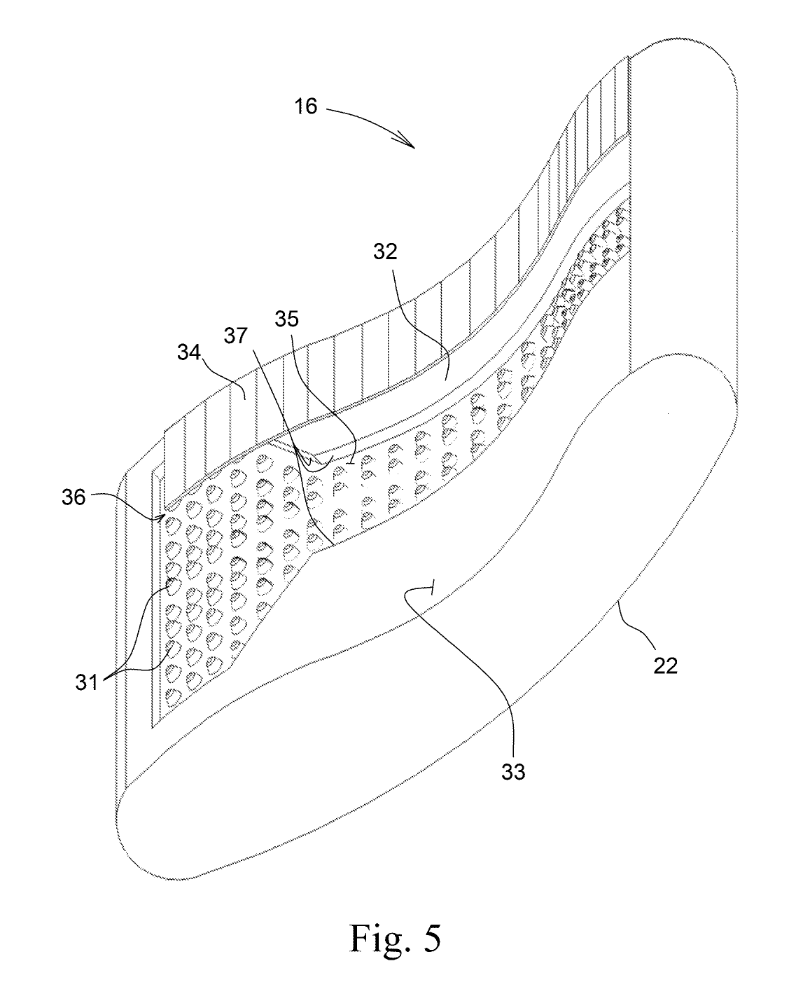

The rounded tips 31 of pegs 30 project proudly from recess surface 35 and are disposed free of foam 32 within void 36. With particular reference to FIG. 5, void space 36 is revealed by cover 34 being shown partially cut away. Void space 36 permits cover 34 to contact pressure points 31 of pegs 30 directly and conform thereto as the person leans back against backrest 16, thereby allowing pressure points 31 to generate sufficient pressure against the person's back to effect afferentation of the mechanoreceptors to alleviate pain.

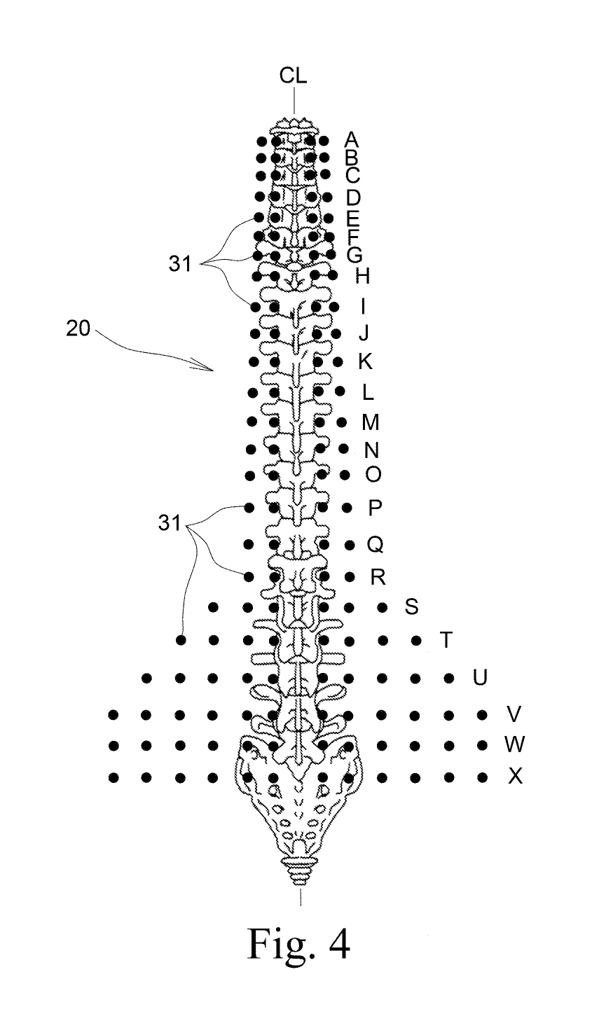

Referring especially to FIG. 4, the location of the rows of pressure points 31 relative to each of the spinal vertebrae and the centerline CL of the spine 20 is illustrated. The first row A of pressure points 31 corresponding to the 2^{nd} cervical vertebrae includes four horizontally spaced pressure points. Two medial pressure points are spaced on centers located approximately 0.5 inches either side of the center line CL. An additional lateral pressure point is spaced approximately 0.5 inches center to center laterally of each medial pressure point. The 16^{th} row P of pressure points 31 corresponding to the 10^{th} thoracic vertebrae includes four horizontally spaced pressure points. Two medial pressure points are spaced on centers located approximately 0.75 inches either side of the center line CL. An additional lateral pressure point is spaced approximately 0.75 inches center to center laterally of each medial pressure point. Each of the rows B through O between rows A and P similarly include four horizontally spaced pressure points 31, however, between rows A and P, the horizontal spacing of the medial pressure points 31 of each row B through O from center line CL vary linearly from 0.5 to 0.75 inches according to the distance of the row from row A. The spacing between the medial and lateral pressure points likewise varies according to the same taper, from 0.5 inches to 0.75 inches. Each of rows A through P) includes four horizontally spaced pressure points 31.

Rows Q and R, corresponding to the 11^{th} and 12 thoracic vertebrae, each include four pressure points 31 located and spaced horizontally the same as the pressure points of row P. Likewise, rows S through X, corresponding to the 1^{st} lumber vertebrae through the 1^{st} sacral vertebrae, also each include four pressure points 31 located and spaced horizontally the same as the pressure points of row P. However, in row S, an additional lateral pressure point is spaced approximately 1.0 inch center to center laterally of the second pressure point on either side of the CL of spine 20, thereby providing a total of six pressure points in row S.

In each of rows T, U and V, corresponding to the 2^{nd}, 3^{rd} and 4^{th} lumbar vertebrae, an additional lateral pressure point is spaced approximately 1.0 inch center to center laterally of the previously outermost pressure point, such that row T has a total of eight pressure points, row U has a total of 10 pressure points, and row V has a total of twelve pressure points. Rows W and X, corresponding to the 5^{th} lumbar vertebrae and the 1^{st} sacral vertebrae, are configured the same as row V with a total of twelve pressure points in each row.

The number and horizontal spacing of pressure points 31 in each of rows A through X, relative to the centerline CL of spine 20, are selected to correspond approximately to the locations of the bladder meridians of a person seated in chair 10 whereby mechanoreceptors thereat are engaged and stimulated by pressure points 31 to cause afferentation for the relief of pain. In a static chair, the mechanoreceptors are stimulated by minor movement of the person sitting back against the pressure points. In a dynamic chair such as a swing chair of the type illustrated herein, the mechanoreceptors are further stimulated as a result of the movement of the person's back while the person rocks thereon. Alternatively, the backrest of the present invention can be utilized with a typical rocking chair and other chairs with backrests which are dynamic/moveable.

Preferably, the chair backrest is custom formed to a person's back thereby fitting the surface of the back of the chair against the person's back and accurately locating the projections at the person's bladder meridians and in corresponding alignment with the vertebrae.

The following measured parameters of the spine are useful for constructing an ergonomic seat back: (1) from the sagittal weight bearing line to the maximum lordotic level of the sagittal cervical spine curve; (2) from the sagittal weight bearing line to the maximum kyphotic thoracic spine level; (3) from the sagittal weight bearing line to the maximum lumbar lordotic curve; and, (4) from the sagittal weight bearing line to the posterior sacrum at maximum kyphosis.

Other useful measured parameters include the vertical distances between the maximum lordotic level of the sagittal spine and the maximum kyphotic level of the thoracic spine, and from the latter to the maximum lordotic level of the lumber spine, and thence from the latter to the maximum kyphosis level of the posterior sacrum.

Using the above measurements, a backrest is constructed wherein the vertical location of each row of pressure points 30 and their angular orientations in the sagittal plane are custom selected so that each row is placed and oriented as first described above with respect to FIGS. 3 and 4.

While this invention has been described as having an exemplary design, the present invention may be further modified within the spirit and scope of this disclosure. This application is therefore intended to cover any variations, uses, or adaptations of the invention using its general principles.

1. A chair having a backrest comprising:
a plurality of pressure points arranged in multiple rows, each row corresponding to a vertebrae of a human spine, said rows being disposed within cervical, thoracic and lumbar sections;
each of the rows within the cervical section corresponding to a different vertebrae and having at least four pressure points spaced laterally;
each of the rows within the thoracic section corresponding to a different vertebrae and having at least four pressure points spaced laterally; and
each of the rows within the lumbar section corresponding to a different vertebrae and having more than four pressure points spaced laterally.

2. The chair of claim 1, wherein each of said pressure points comprises a separate protuberance embedded within a layer of elastomeric foam material and each protuberance includes a tip portion that is free of said layer of foam material.

3. The chair of claim 1, and further including a layer of elastomeric foam material, wherein each pressure point includes a tip portion that is free of said layer of foam material.

4. The chair of claim 1, wherein the row of pressure points corresponding to the first lumbar vertebrae includes at least six pressure points, the row of pressure points corresponding to the second lumbar vertebrae includes at least eight pressure points, and the row of pressure points corresponding to the third lumbar vertebrae includes at least ten pressure points.

5. The chair of claim 4, wherein the rows of pressure points corresponding to the fourth lumbar vertebrae, the fifth lumbar vertebrae, and the first sacral vertebrae each include at least twelve pressure points.

6. The chair of claim 5, wherein each of said pressure points comprises a separate protuberance embedded within a layer of elastomeric foam material and each protuberance includes a tip portion that is free of said layer of foam material.

7. The chair of claim 1, wherein said backrest is anatomically curved and includes an adjustable element connected to said pressure points for varying the curvature of the backrest.

8. The chair of claim 7, wherein said adjustable element includes a flexible sheet and adjustable supports connected to said flexible sheet.

9. A chair having a mounting assembly supporting a seat and a backrest, the backrest adapted to pivot relative to or with the mounting assembly, the backrest comprising:
a plurality of pressure points arranged in multiple rows, each row corresponding to a vertebrae, said rows being disposed within cervical, thoracic and lumbar sections;
each of the rows within the cervical section corresponding to a different vertebrae and having at least four pressure points spaced laterally;
each of the rows within the thoracic section corresponding to a different vertebrae and having at least four pressure points spaced laterally; and,
each of the rows within the lumbar section corresponding to a different vertebrae and having more than four pressure points spaced laterally.

10. The chair of claim 9, wherein each of said pressure points comprises a separate protuberance embedded within a layer of elastomeric foam material and each protuberance includes a tip portion that is free of said layer of foam material.

11. The chair of claim 9, wherein the row of pressure points corresponding to the first lumbar vertebrae includes at least six pressure points, and the row of pressure points corresponding to the second lumbar vertebrae includes at least eight pressure points.

12. The chair of claim 9, wherein said backrest is anatomically curved and includes an adjustable element connected to said pressure points for varying the curvature of the backrest.

13. The chair of claim 12, wherein said adjustable element includes a flexible sheet and adjustable supports connected to said flexible sheet.

14. A chair having a backrest comprising:
a plurality of pressure points arranged in multiple rows, each row corresponding to a different vertebrae, said rows being disposed within cervical, thoracic and lumbar sections;
wherein each of said pressure points comprises a separate protuberance;
wherein said protuberances project from a layer of elastomeric foam material; and,
wherein each protuberance includes a tip portion that is free of said layer of foam material.

15. The chair of claim 14 wherein said layer of elastomeric material comprises a recessed surface relative to a backrest supporting surface thereby defining a recess and wherein said tip portions of said protuberances are located in said recess and project from said recess surface.

16. The chair of claim 15 further comprising a flexible cover extending over said recess surface and being in contact with said backrest surface forming a void between said cover and said recessed surface wherein said protuberance tip portions are located.

17. The chair of claim 16 wherein said backrest is adapted to move relative to or with said chair.

18. The chair of claim 17 wherein said recessed surface and said supporting surface extend along said backrest cervical, thoracic and lumbar sections and are anatomically curved.

19. The chair of claim 18 wherein said elastomeric material and plurality of pressure points are supported on a flexible sheet and said flexible sheet is connected to adjustable supports whereby said flexible sheet is selectively adjusted for adjusting the anatomical curvature of said cervical, thoracic and lumbar sections.

20. The chair of claim 14 wherein said backrest is adapted to move relative to or with said chair.

21. The chair of claim 20 wherein said elastomeric material and plurality of pressure points are supported on a flexible sheet and said flexible sheet is connected to adjustable supports whereby said flexible sheet is selectively adjusted for adjusting the anatomical curvature of said cervical, thoracic and lumbar sections.

22. The chair of claim 14 wherein said elastomeric material and plurality of pressure points are supported on a flexible sheet and said flexible sheet is connected to adjustable supports whereby said flexible sheet is selectively adjusted for adjusting the anatomical curvature of said cervical, thoracic and lumbar sections.

23. A method of making a chair having a backrest comprising the steps of:
a) measuring parameters of the spine of a person for whom the chair is to be made; and,
b) making a backrest having:
a plurality of pressure points arranged in multiple rows, each row corresponding to and aligned with a vertebrae of the spine; each of said pressure points comprising a separate protuberance;
a layer of elastomeric foam material from which said protuberances project, each protuberance including a tip portion that is free of said layer of foam material;
wherein said rows are arranged within cervical, thoracic and lumbar sections;
each of the rows within the cervical section corresponds to a different vertebrae and has at least four pressure points spaced laterally;
each of the rows within the thoracic section corresponds to a different vertebrae and has at least four pressure points spaced laterally; and,
each of the rows within the lumbar section corresponds to a different vertebrae and has more than four pressure points spaced laterally.

24. (canceled)

25. The method of claim 23 wherein said layer of elastomeric material comprises a recessed surface relative to a backrest supporting surface thereby defining a recess and wherein said tip portions of said protuberances are located in said recess and project from said recess surface.

26. The method of claim 25 wherein a flexible cover is extended over said recess surface and in contact with said backrest surface thereby forming a void between said cover and said recessed surface wherein said protuberance tip portions are located.

27. The method of claim 23 wherein said backrest is mounted on a mounting assembly and is adapted to move relative to or therewith.
